(19) United States
(12) Patent Application Publication
(10) Pub. No.: US 2011/0077985 A1
(43) Pub. Date: Mar. 31, 2011

(54) ARCHETYPES MANAGEMENT SYSTEM

(75) Inventors: Wolfgang Peter, Bruchsal (DE); Clemens Suter-Crazzolara, Hockenheim (DE); Thomas Fischer, Waldkirch (DE)

(73) Assignee: SAP AG

(21) Appl. No.: 12/569,781

(22) Filed: Sep. 29, 2009

(51) Int. Cl. G06Q 10/00

(52) U.S. Cl. 705/7; 705/1.1

(57) ABSTRACT

A system includes a sales tool which may provide a first portion of a functionality, an implementation tool which may provide a second portion of the functionality, a development tool which may provide a third portion of the functionality, and a normalization module which may integrate the first portion, the second portion and the third portion to provide the functionality.

### BACKGROUND

The present disclosure relates generally to the field of system/product construction. More specifically, the disclosure relates to innovative systems and methods utilized in the construction of an enterprise computing system.

### SUMMARY

One embodiment of the disclosure relates to a system. The system includes a sales tool which may provide a first portion of a functionality, an implementation tool which may provide a second portion of the functionality, a development tool which may provide a third portion of the functionality, and a normalization module which may integrate the first portion, the second portion and the third portion to provide the functionality. The normalization module may generate an integration architecture based on the integration of the first portion, the second portion, and the third portion

Another embodiment of the disclosure relates to a system. The system includes an interface which may receive project data. The project data may relate to an enterprise computing system. The system further includes an archetype module which may include processing logic. The archetype module may determine an archetype based on the project data.

Another embodiment of the disclosure relates to a method for manufacturing. The method includes determining a project type based on project data and determining functions for the construction of the project based on the project type. The method further includes generating an implementation module, a sales module, a development module, and a normalized architecture for these functions. Also, the method includes generating an archetype based on the implementation module, sales module, development module, and normalized architecture.

### BRIEF DESCRIPTION OF THE DRAWINGS

FIG. 1 is a block diagram, according to an exemplary embodiment;

FIG. 2A is an illustration of an operable system and inoperable system, according to an exemplary embodiment;

FIG. 2B is an illustration of the system, according to an exemplary embodiment;

FIG. 3 is another block diagram, according to an exemplary embodiment;

FIG. 4 is a block diagram of an archetype processing logic; according to an exemplary embodiment;

FIG. 5 is an illustration of the system, according to an exemplary embodiment;

FIG. 6 is an illustration of a portion of the system, according to an exemplary embodiment;

FIG. 7 is a flowchart of an operating procedure; according to an exemplary embodiment;

FIG. 8 is an alternative block diagram, according to an exemplary embodiment; and

FIG. 9 is a flowchart of archetype creation process, according to an exemplary embodiment.

### DETAILED DESCRIPTION OF THE EXEMPLARY EMBODIMENTS

In an exemplary embodiment, when a customer requests to have a system constructed to solve a particular problem, there are multiple views of the problem, the solution, and ways of implementing the solution. For example, the customer has one view, the sales group may have a second view, the implementation group may have a third view, and the development group may have a fourth view. The customer may state this view as the customer has a problem/idea and wants the optimal solution that fits into the customer's current and future processes and IT landscape. The customer wants the functionality and usability listed in their request for proposal (“RFP”) but may not place significant priority on what applications, toolboxes, releases, upgrades, etc. are utilized to obtain this functionality and usability.

The sales group may have a number of products (e.g., product one, product two, product three, etc.) to offer to the customer. The sales group may want the customer to utilize their products and may want to show why their products provide the desired functionality and usability. The sales group may utilize terminology, such as, price list items, campaign, solution, business process, LOB, project, demo, buying center, etc. However, these terms either have different meanings to the implementation group/development group or are not well understood by the implementation group/development group.

The implementation group may have a number of different ways (e.g., implementation plans) to implement the project and with a well structured project map the implementation group may determine the most optimal way to construct the system. The implementation group may utilize terminology, such as, project, method, milestone, best practice, business process, interfaces, standard & legacy, benchmarks, business & IT expertise, etc. However, these terms either have different meanings to the sales group/development group or are not well understood by the sales group/development group.

The development group may have a number of different applications to offer the customer. The development group may want the customer to utilize their applications and wants to show (e.g., demonstrations) how easy it can be to implement. The development group may utilize terminology, such as, solution map, scenario, business process, step, module, application, xApp, business object, composite, etc. However, these terms either have different meanings to the implementation group/sales group or are not well understood by the implementation group/sales group.

Since all three groups utilize different tools, terms, semantics, and granularity to deliver the functionality (e.g., function one, function two, function three, etc.) that is required to complete the system, a unification function may simplify the construction of the system. There is one common term (e.g., level of the construction) which may be utilized by all three groups, which is the project level/term. This unification function may be utilized to create standard projects (e.g., archetypes) which may provide a portion of the functionality required to construct the system or the entire functionality required to construct the system. Each archetype may map in a predefined way to the products and implementation plans used by the sales, development, and implementation groups, even though those groups use different tools, terms, semantics, and granularity to describe the project.

The sales group, the implementation group, and the development group may modify their tools and methods while still delivering the required information to a common level system interface (e.g., common communications portal). In another exemplary embodiment, the common level system interface may be individual interfaces (e.g., sales interface, an implementation interface, and a development interface).

The archetypes may be a grouping of functional elements which provide a standardized way to construct the system. Archetypes may be provided for customer projects relating to industry specific scenarios. Archetypes may have no/low industry specific content (e.g., new payroll, new purchasing process). Archetypes may have high industry specific content (e.g., Trade Promotion Management “TPM” or Direct Store Delivery “DSD”) Archetypes may have different sizes and implementation formats for each project. The sales group may sell one-to-one for these customer projects. The development group may deliver one-to-one in support of these customer projects. The implementation group may utilizing the best practices established to build one-to-one solutions for these customer projects.

In an exemplary embodiment, the archetypes and the assigned attributes may be in a computing device. In another exemplary embodiment, the computing device may be able to search for an archetype based on inputs from the sales group, the implementation group, and/or the development group. This search may be based on key words. In an exemplary embodiment, the computing device may be utilized as a translator/interface between the sales group, the implementation group, and the development group.

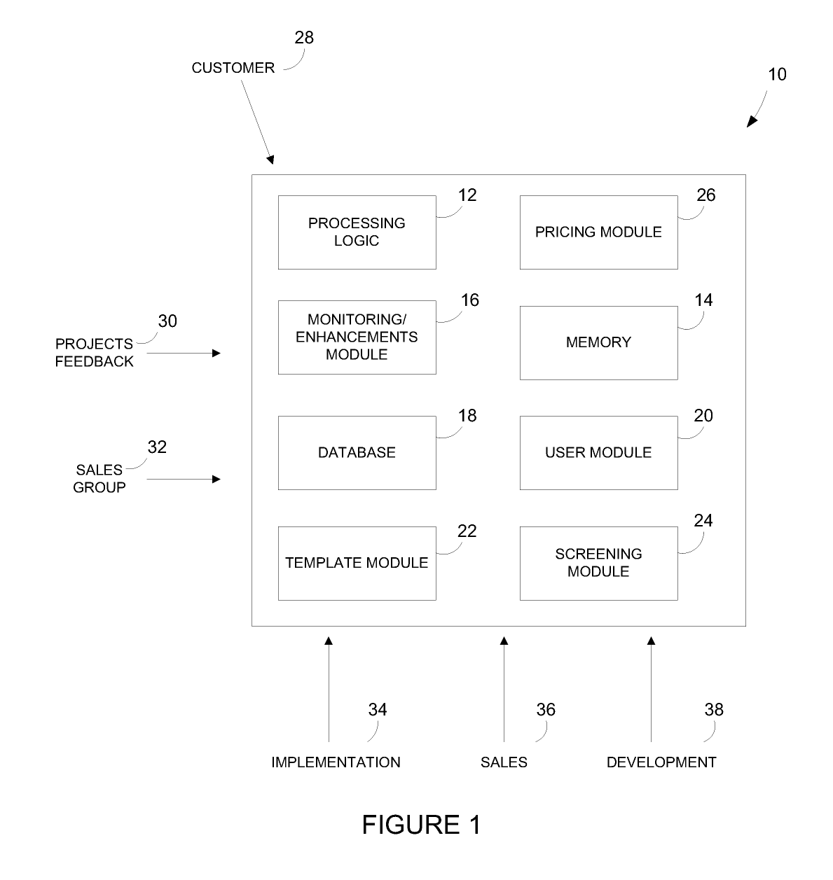

Referring to FIG. 1, a block diagram of an archetype system 10 is shown, according to an exemplary embodiment. Archetype system 10 may include a processing logic 12, a memory 14, a monitoring module 16, a database 18, a user module 20, a template module 22, a screening module 24, and/or a pricing module 26. Archetype system 10 may receive data from a customer data source 28, a project data source 30, a sales group data source 32, an implementation data source 34, a sales data source 36, and/or a development data source 38.

Customer data source 28 may provide data including timeline information (e.g., start date, end date, milestones, etc.), pricing/budget information ((e.g., total budget, budget spent, budget remaining, percent utilized, percent not utilized, budget status (e.g., on target, behind, ahead)), customer contact information (e.g., project leader, business leaders, etc.), or customer feedback on project.

Project data source 30 may provide data including project status information (e.g., steps completed, steps not completed, on-time, behind schedule, ahead of schedule, on-budget, over-budget, under-budget, or trend lines) and information relating to project problems (e.g., the XYZ product is not working with the ABC system).

Sales group data source 32 may provide data including new versions (e.g., features) of the system being requested by clients or potential clients or information (e.g., price, features, benefits) on competitor's products.

Implementation data source 34 may provide data including implementation timeline information, product features, code data, integration options, integration procedures, or any other information relating to implementation.

Sales data source 36 may provide data including sales timeline information, product features, code data, integration options, integration procedures, or any other information relating to sales.

Development data source 38 may provide data including development timeline information, product features, code data, integration options, integration procedures, or any other information relating to development.

In an exemplary embodiment, database 18 may include one, a few, or a plurality of archetypes. Processing logic 12 may access template module 22 and database 18 to generate the project archetype. In an exemplary embodiment, template module 22 utilizes archetypes in database 18 to determine the project archetype based on project data. In an exemplary embodiment, screening module 24 may be utilized to determine project data and/or the project archetype. User module 20 may be utilized to determine any criteria for any of the other modules based on the user's data. For example, client X only utilizes certain archetypes. Therefore, only these archetypes will be utilized in template module 22 and screening module 24. In other examples, a project manager may be an expert in archetype one and is only assigned to projects utilizing archetype one; a sales person is an expert in archetype category (e.g., archetype one to ten); and a development team works on two different archetype only (e.g., archetype one and archetype one hundred). Processing logic 12 may be implemented in program logic in a computer system.

Monitoring module 16 may obtain feedback from any data sources (e.g., customer data source 28, project data source 30, sales data source 32, implementation data source 34, sales data source 36, development data source 38, or etc.), processing logic 12 (e.g., control circuit, control module, etc.), database 18, user module 20, template module 22, screening module 24, or pricing module 26. For example, during a project implementation, enhanced features may be developed by the implementation group, sales group, development group, or any other group which may be incorporated into the archetype or utilized to create a new archetype. In another example, based on project feedback screening module 24 may be modified to allow screening module 24 to generate different project data based on project input data.

In an exemplary embodiment, pricing module 26 may be utilized to generate a customer proposal based on which archetype was selected. Further, pricing module 26 may be modified based on information received by monitoring module 16.

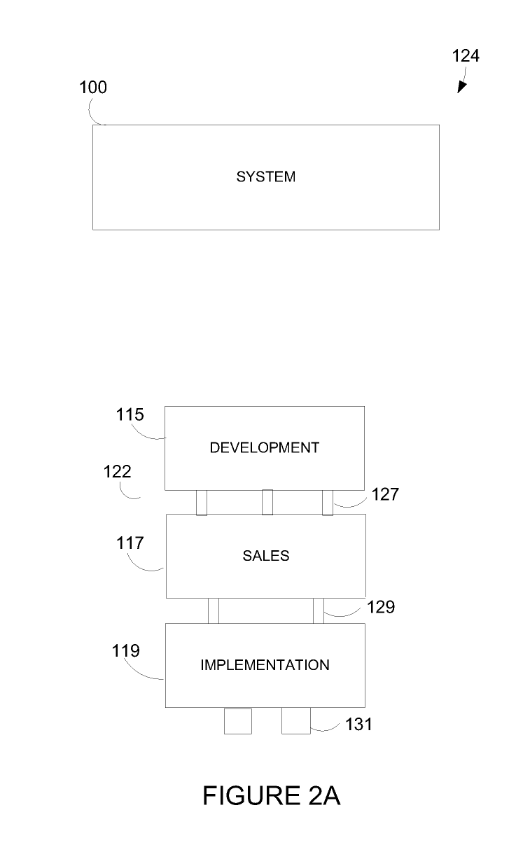

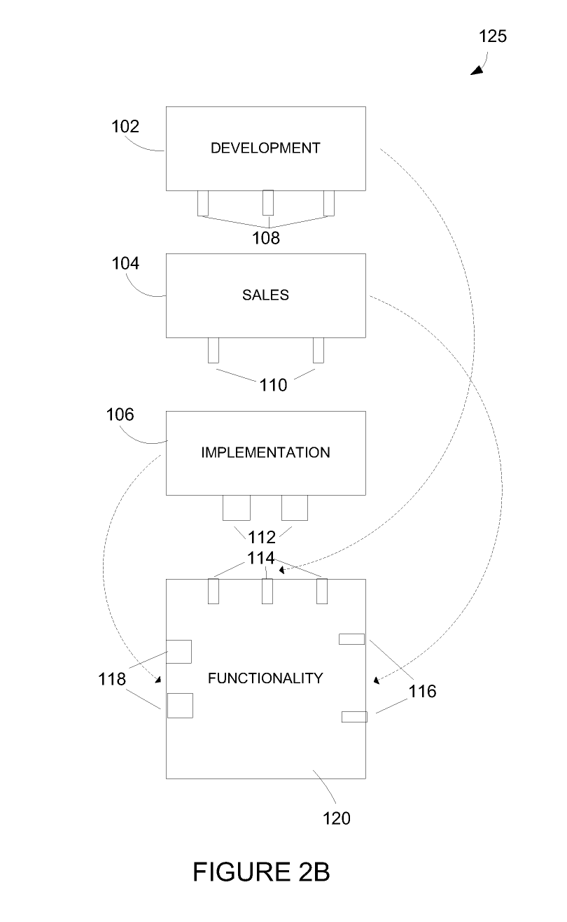

In FIG. 2A, illustrations 124 of an inoperable system 122 and an operable system 100 are shown, according to exemplary embodiments. Inoperable system 122 may include a first non-functioning communication link 127, a second non-functioning communication link 129, and a third non-functioning communication link 131. First non-functioning communication link 127 is inoperable because a development module 115 utilizes different terminology then either a sales module 117 and/or an implementation module 119. Second non-functioning communication link 129 is inoperable because sales module 117 utilizes different terminology then either development module 115 and/or implementation module 119. Third non-functioning communication link 131 is inoperable because implementation module 119 utilizes different terminology then either development module 115 and/or sales module 117.

In FIG. 2B, an illustration of a system 125 is shown, according to an exemplary embodiment. In an exemplary embodiment, the construction of a system 100 may include a development portion 102, a sales portion 104, and an implementation portion 106. Development portion 102 may include a development integration point 108. Sales portion 104 may include a sales integration point 110. Implementation portion 106 may include an implementation integration point 112. In an exemplary embodiment, development portion 102, sales portion 104, and implementation portion 106 may not be directly combined because development integration point 108, sales integration point 110, and implementation integration point 112 are not directly compatible. In an exemplary embodiment, development integration point 108, sales integration point 110, and implementation integration point 112 may not be directly combined into an integrated (e.g., working) system without extensive processing/programming.

In exemplary embodiments, the sales group may utilize various tools (e.g., MS Office, etc.), implementation group may utilize various tools (e.g., MS project, Excel, etc.), and development group may utilize various tools (e.g., MS Visual Studio, SAP developer workbench, etc.).

In an exemplary embodiment, a functionality module 120 may include a development input area 114, a sales input area 116, and an implementation input area 118. Functionality module 120 may be any function of the system (e.g., user interface, database management, logic functions, reporting functions, security functions, etc.). Development input area 114 may interface with development portion 102 which allows for development portion 102 to be modified without modifications to functionality module 120. Sales input area 116 may interface with sales portion 104 which allows for sales portion 104 to be modified without modifications to functionality module 120. Implementation input area 118 may interface with development portion 106 which allows for development portion 106 to be modified without modifications to functionality module 120.

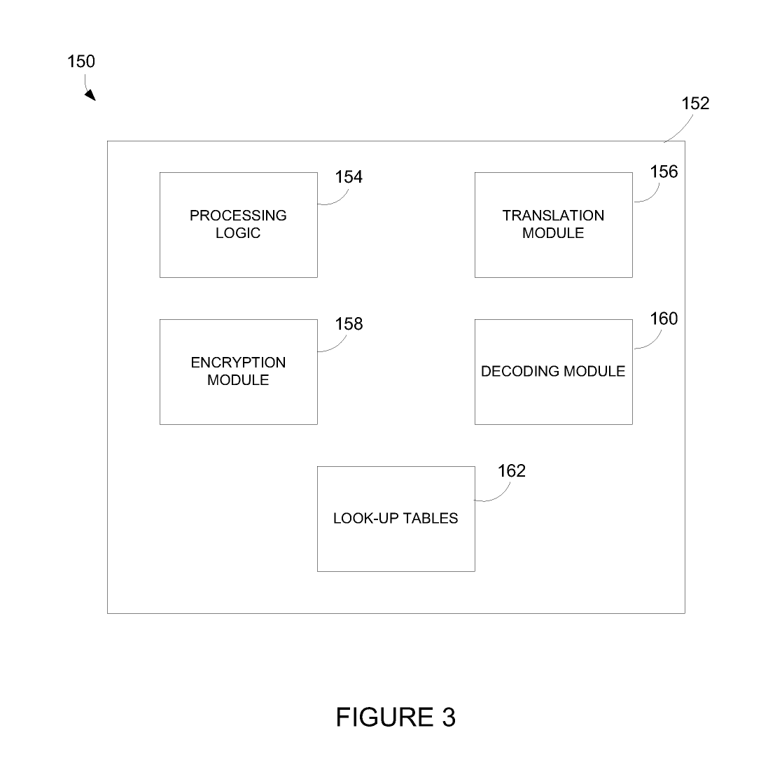

In FIG. 3, a block diagram 150 of an archetype system 152 is shown, according to an exemplary embodiment. Archetype system 152 may include a processing logic 154, a translation module 156, an encryption module 158, a decoding module 160, and look-up tables 162. Processing logic 154 may utilize translation module 156 to communicate with development portion 102, sales portion 104, and implementation portion 106. In another exemplary embodiment, processing logic 154 may utilize translation module 156 to communication with development portion 102, sales portion 104, and implementation portion 106 via development integration point 108, sales integration point 110, implementation integration point 112. In addition, processing logic 154 may utilize translation module 156 to communication with development portion 102, sales portion 104, and implementation portion 106 via development input area 114, sales input area 116, implementation input area 118. In another exemplary embodiment, translation module 156 may utilize look-up tables 162 to interpret/translate communications between development portion 102, sales portion 104, implementation portion 106, monitoring module 16, user module 20, template module 22, screening module 24, or pricing module 26.

Processing logic 154 may utilize encryption module 158 and decoding module 160 to provide security functionality (e.g., level one, level two, level three, etc.) for any system communication. For example, competitive intelligence information may be received by monitoring module 16 which may be encrypted for security reasons. In another example, encrypted information received from development portion 102 may be decoded once the information is in a secure environment.

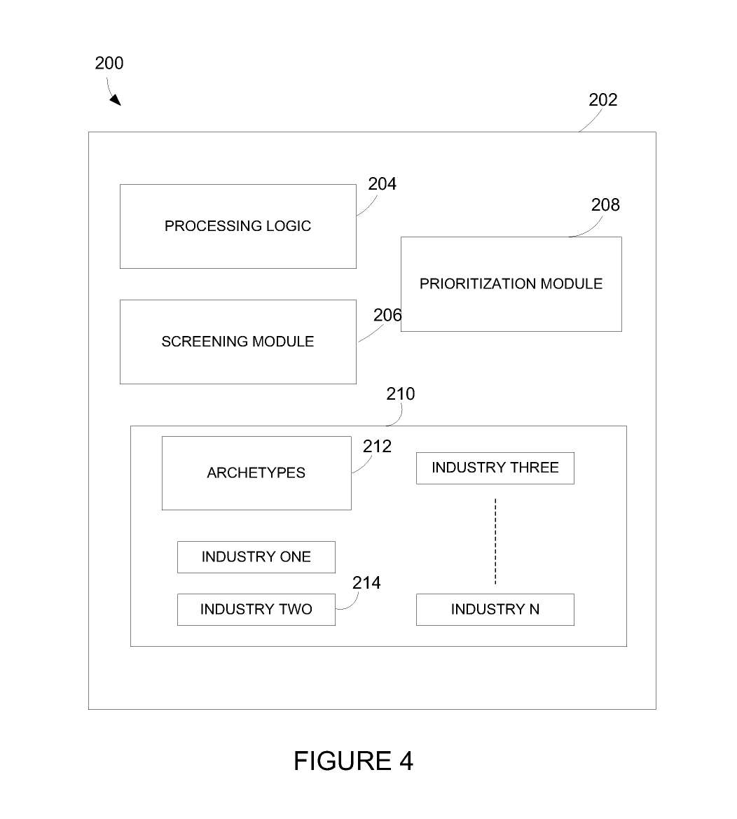

In FIG. 4, a block diagram 200 of an archetype processing logic 202 is shown; according to an exemplary embodiment. Archetype processing logic 202 may include a processing logic 204, a screening module 206, a prioritization module 208, and an archetype database 210. Archetype database 210 may include archetypes 212. Archetypes 212 may be individual units, grouped by industry (e.g., retail, power generation, law firms, semiconductor manufacturers, etc.), grouped by application (e.g., inventory management, sales management, production management), grouped by enterprise solution (e.g., CRM), grouped by pricing structure, or grouped by category (e.g., industry). In an exemplary embodiment, archetypes 212 may include a plurality of industry archetypes 214. For example, archetypes 212 may include an industry one, an industry two, an industry three, . . . , and an industry N archetypes. In an exemplary embodiment, processing logic 204 may utilize screening module 206 and/or prioritization module 208 to select archetypes 212. For example, project data may be utilized by screening module 206 to select one, a few, or many archetypes 212 that may be utilized to construct the system. Prioritization module 208 may analyze the few or many archetypes 212 selected by screening module 206 to rank archetypes 212 based on any prioritization criteria (e.g., price, implementation complexity, customer preferences, supplier preferences, project implementation time, or personnel allocation).

For example, screening module 206 selects archetype one, archetype two, and archetype three. Archetype one has the lowest cost but has the longest implementation time because the individuals required (e.g., personnel allocation) for this project's implementation are not available (e.g., on other projects) for one year. Archetype two has the highest cost but the quickest completion time (e.g., one month). Archetype three has a slightly higher cost than archetype one, has medium implementation complexity, and can be completed in three months. Prioritization module 208 may rank these three archetypes based on this information for client one as: 1) Archetype three; 2) Archetype one; and 3) Archetype two.

However, prioritization module 208 may rank these three archetypes based on this information for client two (who needs the project completed as soon as possible) as: 1) Archetype two; 2) Archetype three; and 3) Archetype one.

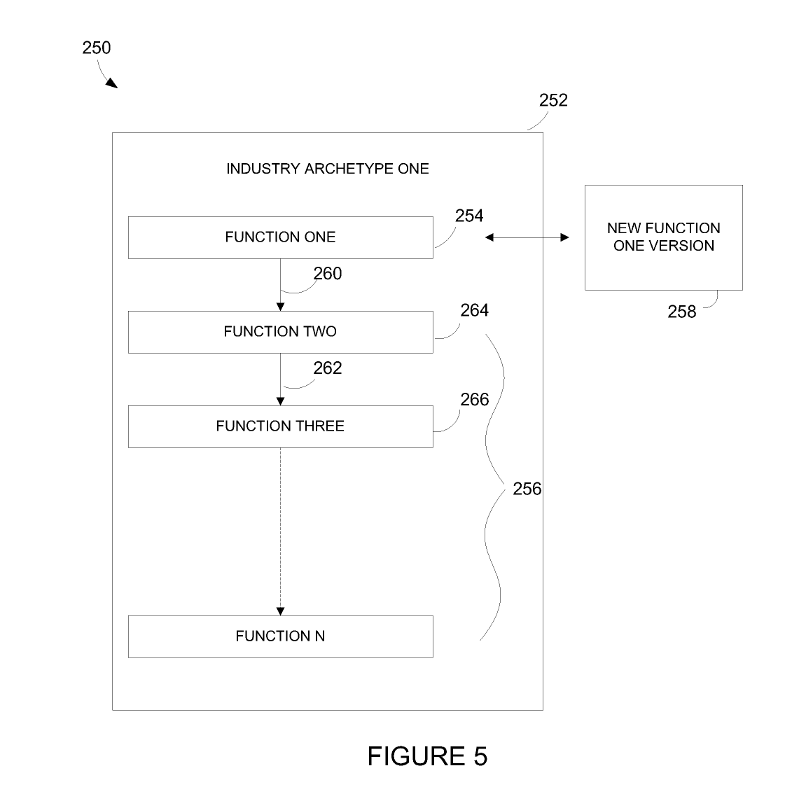

In FIG. 5, an illustration 250 of an archetype profile 252 is shown, according to an exemplary embodiment. Archetype profile 252 may include a function one 254 and a plurality of functions 256. In an exemplary embodiment, archetype profile 252 may include a few, many, or all of the functions required to implement the system. In an exemplary embodiment, function one 254 may include development portion 102, sales portion 104, and implementation portion 106. Function one 254 may be replaced/modified by a new function one version 258. In an exemplary embodiment, the replacement/modification of function one 254 may not require any modifications to a first communication link 260 between function one 254 and a function two 264. Also, the replacement/modification of function two 264 may not require any modifications to first communication link 260 between function one 254 and function two 264. Further, a replacement/modification of function two 264 may not require any modifications to a second communication link 262 between function two 264 and a function three 266. In an exemplary embodiment, any modification to any of the functions (e.g., one through N) may result in no modifications, slight modifications, average modifications, or significant modifications to the communication links.

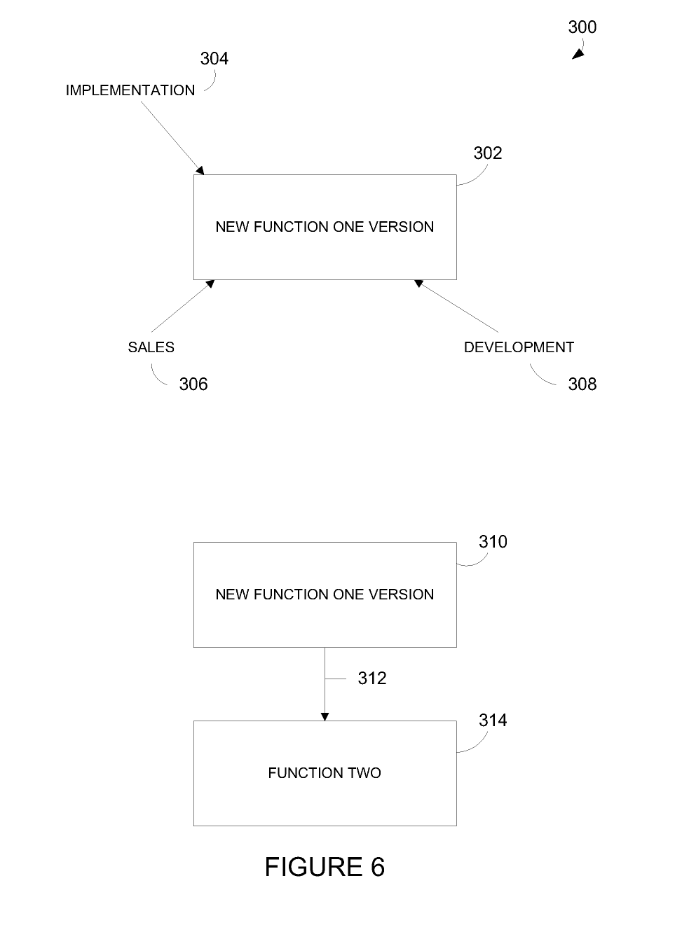

In FIG. 6, an illustration 300 of a new version of a function 302 for the system is shown, according to an exemplary embodiment. New version of the function 302 may be modified based on information received from implementation group 304, sales group 306, development group 308, or any other system/source/module discussed in this disclosure. A new function one version 310 may communicate with a function two 314 via a communication link 314. New function one version 310 may be of modular design which allows for the replacement of function one 254 with new function one version 310 without the need to modify any part of the system.

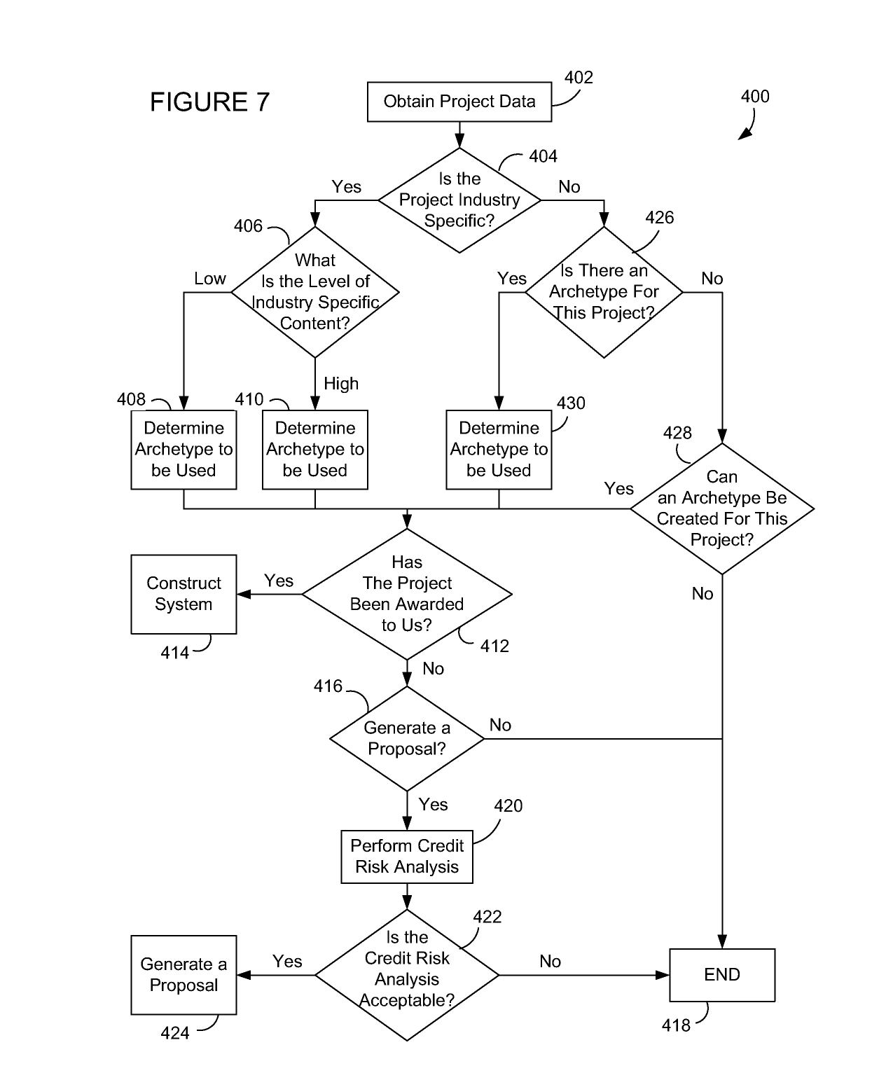

In FIG. 7, a flowchart 400 of an operating procedure is shown, according to an exemplary embodiment. Processing logic 12, 154, 204 may obtain project data (step 402). Processing logic 12, 154, 204 may obtain project data via monitoring module 16, database 18, user module 20, template module 22, screening module 24, pricing module 26, customer data source 28, project data source 30, sales data source 32, implementation data source 34, sales data source 36, development data source 38, translation module 156, encryption module 158, decoding module 160, look-up tables 162, screening module 206, prioritization module 208, archetype database 210, or any other source discussed in this disclosure. The system determines that the project is an industry specific project or is not an industry specific project (step 404). When the project is an industry specific project, the process moves to step 406. The system (e.g., processing logic 12, 154, 204) determines the level of industry specific content (step 406). When the industry specific content is low, the system determines which low industry specific content to be utilized (step 408). When the industry specific content is high, the system determines which high industry specific content to be utilized (step 410). The system determines whether the project has been awarded (step 412). If the project has been awarded, the system starts/allows/approves the construction of the project (step 414). In addition, the system may provide notification(s) of the awarded status. If the project has not been awarded, the system determines whether a proposal may be generated (step 416). If a proposal should not be generated, the process ends (step 418). If a proposal may be generated, the system performs a credit risk analysis (step 420). If the credit risk is unacceptable, the process ends (step 418). If the credit risk is acceptable, a proposal is generated (step 424).

When the project is not an industry specific project, the process moves to step 426. The system determines whether there is an archetype for this project (step 426). If an archetype is available for the project, the system determines the archetype to be utilized (step 430). After the archetype is determined, the system moves on to step 412 above. If an archetype is not available, the system determines whether an archetype can be created for this project (step 428). If an archetype may be created, the system moves on to step 412 above. If an archetype may not be created, the process ends (step 418).

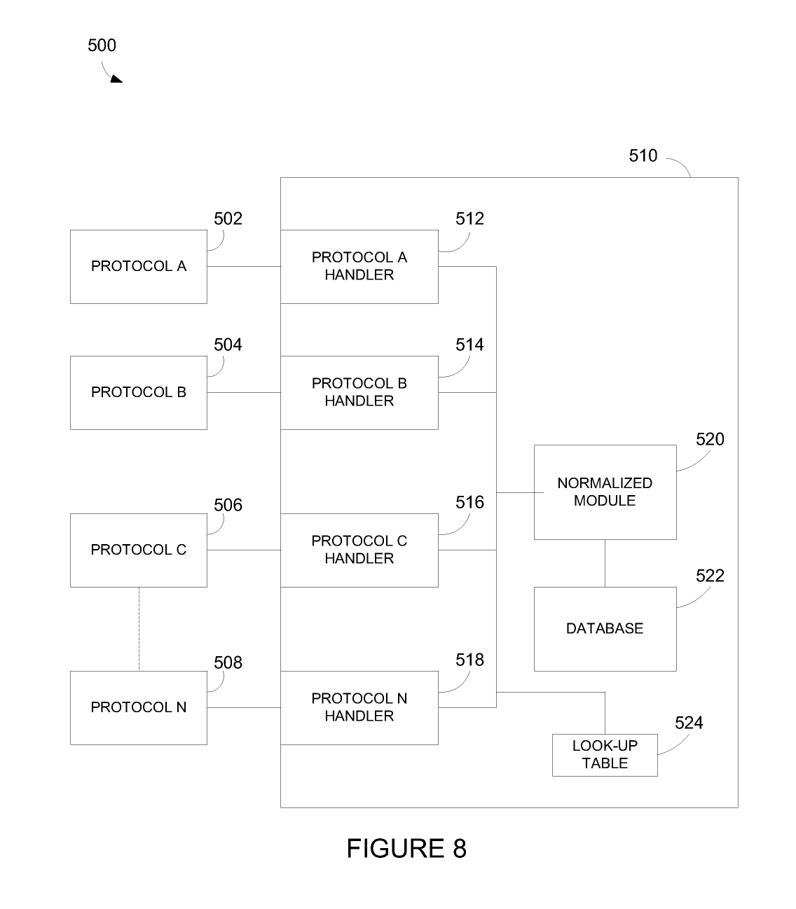

In FIG. 8, an alternative block diagram of an archetype system 500 is shown, according to an exemplary embodiment. Archetype system 500 may include a first protocol structure 502, a second protocol structure 504, a third protocol structure 506, and an Nth protocol structure 508. In an exemplary embodiment, archetype system 500 may also include a conversion module 510. Conversion module 510 may include a first protocol handler 512, a second handler 514, a third protocol handler 516, an Nth protocol handler 518, a normalizing module 520, a database 522, and a look-up table 524. First protocol handler 512 may communicate with first protocol structure 502. Second protocol handler 514 may communicate with second protocol structure 504. Third protocol handler 516 may communicate with third protocol structure 506. Nth protocol handler 518 may communicate with Nth protocol structure 518. Normalizing module 520 may allow for communicate between the different protocols and the different protocol handlers. In an exemplary embodiment, normalizing module 520 may utilized data in look-up tables or database 522.

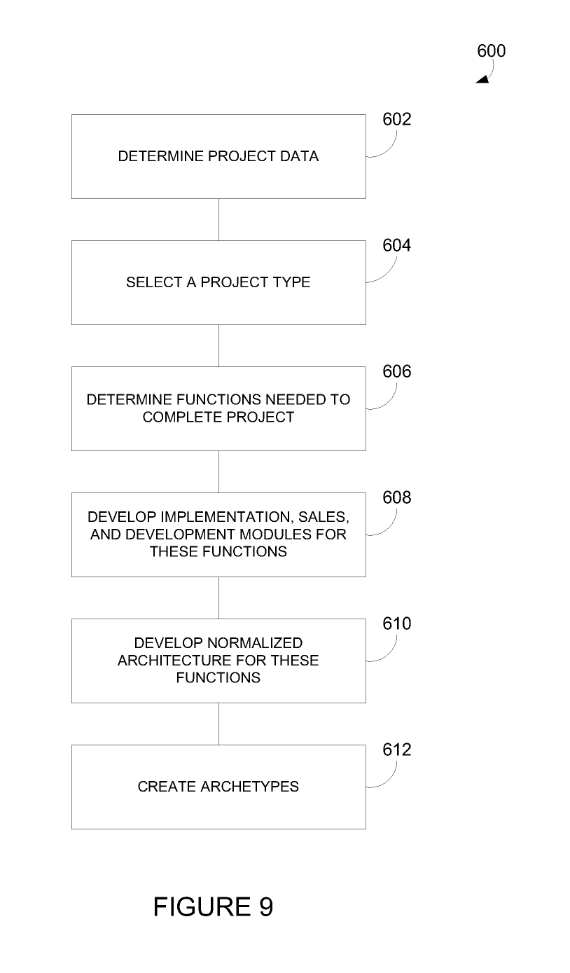

In FIG. 9, a flowchart for an archetype creation process 600 is shown, according to an exemplary embodiment. The system (e.g., processing logic 12, 154, 204) may determine project data (step 602). The system may select a project type based on the project data (step 604). The system may determine the functions needed to complete the project (step 606). The system may generate implementation, sales, and development modules for these functions (step 608). The system may develop a normalized architecture for these functions (step 610). The system may create an archetype based on the normalized architecture, implementation modules, sales modules, and development modules (step 612).

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system. No claim element herein is to be construed under the provisions of 35 U.S.C. §112, sixth paragraph, unless the element is expressly recited using the phrase “means for.” Furthermore, no element, component or method step in the present disclosure is intended to be dedicated to the public, regardless of whether the element, component or method step is explicitly recited in the claims.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the disclosure are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A system comprising:
a sales tool configured to provide a first portion of a functionality;
an implementation tool configured to provide a second portion of the functionality;
a development tool configured to provide a third portion of the functionality; and
a normalization module configured to integrate the first portion, the second portion, and the third portion to provide the functionality, the normalization module further configured to generate an integration architecture based on the integration of the first portion, the second portion, and the third portion.

2. The system of claim 1, further comprising an archetype module configured to generate an archetype based on the integration of the first portion, the second portion, and the third portion.

3. The system of claim 2, further comprising a monitoring module configured to modify the archetype based on external data.

4. The system of claim 3, wherein the external data is project feedback data.

5. The system of claim 1, further comprising a template module configured to store archetypes.

6. The system of claim 5, further comprising a screening module configured to select one or more of a plurality of archetypes stored in the template module based on project data.

7. The system of claim 6, further comprising a prioritization module configured to prioritize the one or more selected archetypes.

8. A system comprising:
a sales tool configured to provide a first portion of a functionality, the sales tool having programmed therein a first mapping function which maps the first portion of the functionality to a plurality of archetypes, each of the plurality of archetypes describing a software system project from a sales perspective, an implementation perspective, and a development perspective, the first mapping function mapping the first portion of the functionality to the archetype from the sales perspective;
an implementation tool configured to provide a second portion of the functionality, the implementation tool having programmed therein a second mapping function which maps the second portion of the functionality to a plurality of archetypes, the second mapping function mapping the second portion of the functionality to the archetype from the implementation perspective; and
a development tool configured to provide a third portion of the functionality, the development tool having programmed therein a third mapping function which maps the third portion of the functionality to a plurality of archetypes, the third mapping function mapping the third portion of the functionality to the archetype from the development perspective.

9. The system of claim 8, further comprising a pricing module configured to generate a construction proposal based on a selected archetype.

10. The system of claim 8, further comprising a screening module configured to select an archetype based on at least one of data received from a user module and project data.

11. The system of claim 8, further comprising a monitoring module configured to modify an archetype based on external data.

12. The system of claim 11, wherein the external data is at least one of implementation data, sales data, and development data.

13. A method of manufacturing a computing system, the method comprising:
determining a project type based on project data;
determining functions to construct a project based on the project type;
generating an implementation module, a sales module, a development module, and a normalized architecture for these functions;
generating an archetype based on the implementation module, sales module, development module, and normalized architecture; and
constructing the computing system according to the archetype.

14. The method of claim 13, further comprising storing the archetype in a template module.
